(19) United States
(12) Patent Application Publication
(10) Pub. No.: US 2023/0394486 A1
(43) Pub. Date: Dec. 7, 2023

(54) INFORMATION PROCESSING SYSTEM, INFORMATION PROCESSING METHOD, AND NON-TRANSITORY COMPUTER READABLE STORAGE MEDIUM STORING PROGRAM

(71) Applicant: Safie Inc., Tokyo (JP)

(72) Inventors: Yoko Koba, Tokyo (JP); Makiko Hirata, Tokyo (JP); Taisei Imada, Tokyo (JP)

(73) Assignee: Safie Inc., Tokyo (JP)

(21) Appl. No.: 18/324,432

(22) Filed: May 26, 2023

(30) Foreign Application Priority Data
Jun. 1, 2022 (JP) 2022-089444

(51) Int. Cl. G06Q 20/40; G06T 11/00; G06V 10/70; G06V 20/52

(52) U.S. Cl. CPC G06Q 20/4016; G06T 11/00; G06V 10/70; G06V 20/52; G06Q 20/407; G06T 2207/30232; G06T 2207/30242; G06T 2207/30196

(57) ABSTRACT

According to an aspect of the present invention, an information processing system is provided. The information processing system is configured to display a captured image regarding a cashier on a screen. The screen includes a timeline regarding the captured image. When the captured image meets a predetermined condition at timing when refund processing is performed at the cashier, an object regarding refund fraud is displayed in association with the timeline.

### CROSS REFERENCE TO RELATED APPLICATIONS

The present application claims priority under 35 U.S.C. § 119 to Japanese Patent Application No. 2022-089444, filed Jun. 1, 2022, the contents of which are incorporated herein by reference in their entirety.

### BACKGROUND

### Technical Field

The present invention relates to an information processing system, an information processing method, and a non-transitory computer readable storage medium storing a program.

### Related Art

JP 2005-115504 A discloses a technology aiming to provide a system for ensuring that accounting processing is performed appropriately by utilizing information that can be obtained from a POS terminal and an image captured by a camera.

One example of fraud existing in an enterprise is to process merchandise at a cashier as if it had been returned by a customer, even if the merchandise has not actually been returned. When such fraud is committed, a staff may be defrauded of amount of cash or the like corresponding to false return of the merchandise. In addition, although an inventory system or the like records that the merchandise was returned, the merchandise is not actually returned, thus inventory cannot be properly managed.

In the technology disclosed by JP 2005-115504 A, to confirm whether such fraud has been committed, it is necessary to input search condition such as transaction date and time, capacity number for identifying capacity, etc. on a search screen. However, since many returned merchandises are processed by store, it is not realistic to check date and time, capacity number, etc. for return processing, input search conditions one by one, and visually check whether fraud has been committed.

According to an aspect of the present invention, an information processing system is provided. The information processing system is configured to display a captured image regarding a cashier on a screen. The screen includes a timeline regarding the captured image. When the captured image meets a predetermined condition at timing when refund processing is performed at the cashier, an object regarding refund fraud is displayed in association with the timeline.

### BRIEF DESCRIPTION OF DRAWINGS

FIG. 1 shows an example of system configuration of an information processing system 1000.

FIG. 2 shows an example of hardware configuration of a server apparatus 100.

FIG. 3 shows an example of hardware configuration of a client apparatus 110.

FIG. 4 is a sequence diagram showing an example of information processing in an information processing system 1000.

FIG. 5 shows an example of refund information.

FIG. 6 is a flowchart showing an example of determination processing.

FIG. 7 shows an example of a screen displayed on an output unit 340 of a client apparatus 110 (first case).

FIG. 8 shows an example of system configuration of an information processing system 1000 according to a first variation.

FIG. 9 is a flowchart showing an example of determination processing according to the first variation.

FIG. 10 shows an example of a screen displayed on an output unit 340 of a client apparatus 110 (second case).

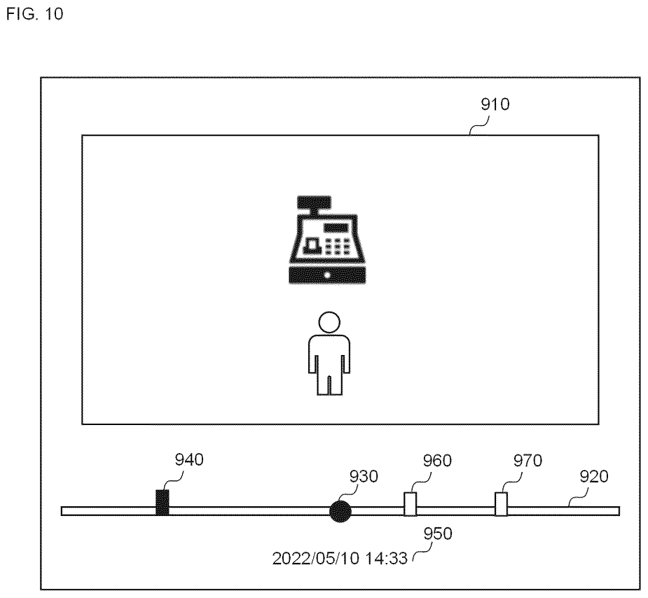

### DETAILED DESCRIPTION

Hereinafter, an embodiment of the present invention will be described with reference to drawings. Various features described in the embodiment below can be combined with each other.

Drawings will be utilized to describe the embodiment of the present invention. Various features described in the embodiment below can be combined with each other. In particular, the term “unit” in the specification may include, for instance, hardware resource implemented by circuits in a broad sense, together with software information processing that can be specifically realized by the hardware resource. In addition, although various information is applied in the present embodiment, such information can be communicated and calculated on circuit in broad sense, regardless of whether the information is represented as a set of binary bits configured of 0 or 1 by high or low signal value, by physical value of signal value, or by quantum superposition.

Further, the circuit in a broad sense is a circuit realized by combining at least an appropriate number of a circuit, a circuitry, a processor, a memory, or the like. In other words, it is a circuit includes application specific integrated circuit (ASIC), programmable logic device (e.g., simple programmable logic device (SPLD), complex programmable logic device (CPLD), field programmable gate array (FPGA)), or the like.

Further, a program for implementing a software appearing in the embodiment may be implemented in a downloadable form from a server, may be executed on a cloud computer, or may be stored and distributed on a non-volatile or volatile non-transitory storage medium.

1. System Configuration

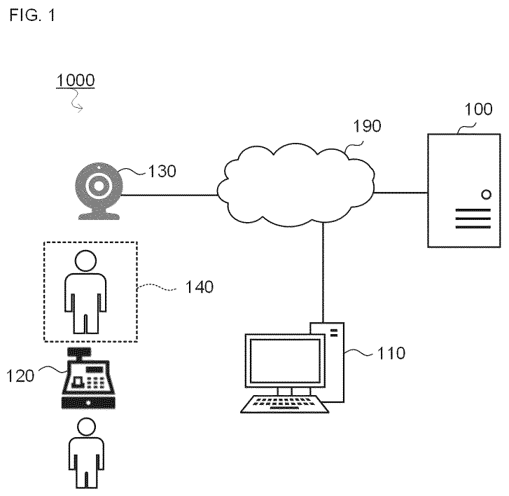

FIG. 1 shows an example of system configuration of an information processing system 1000. As shown in FIG. 1, the information processing system 1000 comprises, as system configuration, a server apparatus 100, a client apparatus 110, a cash register 120, and an imaging apparatus 130. The server apparatus 100, the client apparatus 110, the cash register 120, and the imaging apparatus 130 are communicatively connected via a network 190.

The server apparatus 100 is configured to store a captured image taken by the imaging apparatus 130, analyze the captured image, and transmit an analysis result to the client apparatus 110, etc. The server apparatus 100 may be owned by an enterprise that provides the information processing system 1000, an enterprise that operates a store, or any other third party such as a cloud service provider. The client apparatus 110 is configured to display the captured image received from the server apparatus 100 or the analysis result received from the server apparatus 100. The cash register 120 is a device installed in a store or the like to calculate and record sales total of merchandise. Although two or more cash registers 120 may be installed in a store, for the sake of simplicity, description is given assuming that there is only one cash register 120. The imaging apparatus 130 is a camera installed in the same store as the cash register 120. The imaging apparatus 130 takes image of an area around the cash register 120 and transmits captured image to the server apparatus 100. Here, the imaging apparatus 130 takes image around the cash register 120 so as to include a customer area 140 regarding the cash register 120 and transmits the image to the server apparatus 100. The customer area 140 is set via the client apparatus 110 or the like. The customer area 140 is set so as to include customer lined up at the cash register 120. Although two or more imaging apparatuses 130 may be installed in a store, such as when there are two or more cash registers 120 in a store, for simplicity of explanation, description is given assuming that there is one imaging apparatus 130.

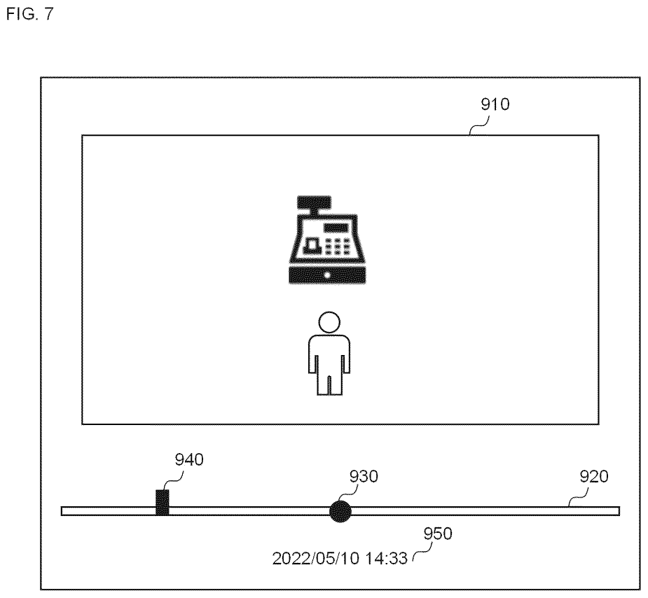

For simplicity of explanation, only one client apparatus 110 is shown in the information processing system 1000 in FIG. 1, but the information processing system 1000 may include two or more client apparatuses 110. Similarly, although FIG. 1 shows only a limited number of various configurations in the information processing system 1000 for simplicity of explanation, the information processing system 1000 may include various configurations not shown in FIG. 1. Further, FIG. 1 shows a PC as an example of the client apparatus 110, but it is not limited thereto, and may be any tablet computer or the like that can display a screen as shown in FIG. 7 described later.

Here, an information processing system described in claim may comprise two or more apparatuses or may comprise a single apparatus. When the information processing system described in the claim comprises a single apparatus, an example of the apparatus is the client apparatus 110. When the information processing system described in the claim comprises two or more apparatuses, an example of the two or more apparatuses is the server apparatus 100 and the client apparatus 110.

2. Hardware Configuration

(Hardware Configuration of Server Apparatus 100)

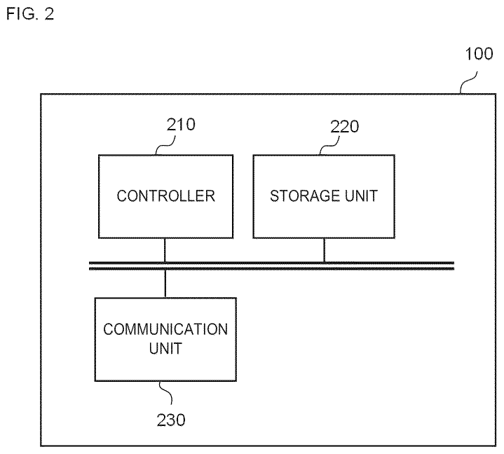

FIG. 2 shows an example of hardware configuration of the server apparatus 100. The server apparatus 100 comprises, as hardware configuration, a controller 210, a storage unit 220, and a communication unit 230.

The controller 210 is a CPU (Central Processing Unit) or the like, and controls entire server apparatus 100. The controller 210 implements function or the like of the server apparatus 100 by executing processing based on a program stored in the storage unit 220.

The storage unit 220 may be any of HDD (Hard Disk Drive), ROM (Read Only Memory), RAM (Random Access Memory), SSD (Solid State Drive), or any combination thereof, and stores a program and data, etc. utilized when the controller 210 executes processing based on the program.

The communication unit 230 is a NIC (Network Interface Card) or the like that connects the server apparatus 100 to the network 190 and manages communication with other apparatus.

(Hardware Configuration of Client Apparatus 110)

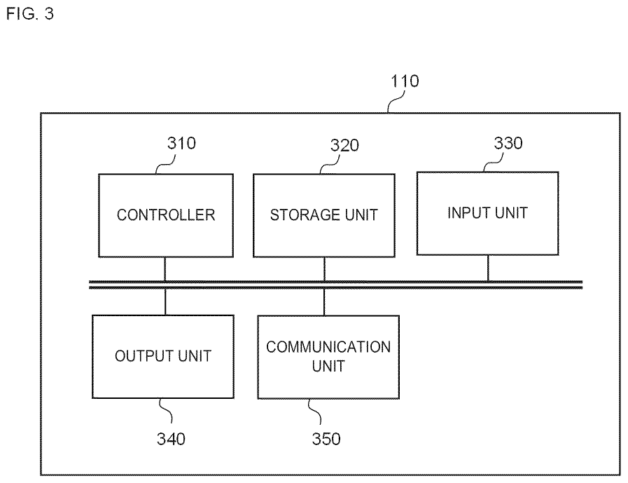

FIG. 3 shows an example of hardware configuration of the client apparatus 110. The client apparatus 110 comprises, as hardware configuration, a controller 310, a storage unit 320, an input unit 330, an output unit 340, and a communication unit 350.

The controller 310 is a CPU or the like that controls entire client apparatus 110.

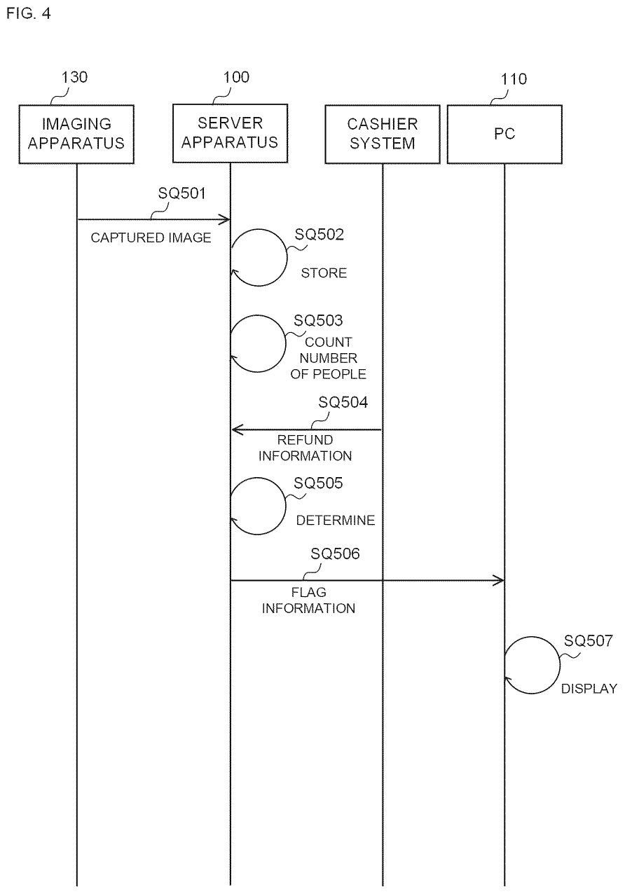

The storage unit 320 may be any of HDD, ROM, RAM, SSD, or any combination thereof, and stores a program and data, etc. utilized when the controller 310 executes processing based on the program. The controller 310 executes processing based on the program stored in the storage unit 320, thereby realizing function of the client apparatus 110 as shown in FIG. 4 described later.

The input unit 330 is a keyboard and/or a mouse, etc., and is configured to input information to the client apparatus 110 based on user operation. The output unit 340 is a display or the like, and is configured to display a screen or the like based on control of the controller 310. The communication unit 350 is a NIC or the like, and is configured to connect the client apparatus 110 to the network 190 and manage communication with other apparatus.

3. Information Processing

Hereinafter, information processing according to the present embodiment will be described.

The controller 310 is configured to display a screen on the output unit 340 as shown in FIG. 7 described later. That is, as described below, the controller 310 displays a captured image regarding the cash register 120 on the screen. The screen includes a timeline regarding the captured image. If the captured image meets a predetermined condition at timing when refund processing is performed at the cash register 120, a flag regarding refund fraud is displayed in association with the timeline. Here, the flag regarding refund fraud is an example of an object regarding refund fraud.

FIG. 4 is a sequence diagram showing an example of information processing in the information processing system 1000.

In sequence SQ501, the imaging apparatus 130 takes image of an area around the cash register 120 including a set area (e.g., the customer area 140) and transmits a captured image to the server apparatus 100. The captured image includes, as attribute information, imaging date and time information, identification information identifying the imaging apparatus 130, or the like.

In sequence SQ502, when receiving the captured image from the imaging apparatus 130, the controller 210 of the server apparatus 100 temporarily stores the received captured image in a predetermined storage area such as the storage unit 220.

In sequence SQ503, the controller 210 counts number of people in a predetermined area of the captured image that is temporarily stored in a predetermined storage area. For instance, the controller 210 counts number of people in the customer area 140 of the captured image. The controller 210 stores information on which area the number of people was counted or information on counted number of people in a predetermined storage area such as the storage unit 220 in association with the captured image.

In sequence SQ504, the controller 210 receives refund information from a cashier system indicating that refund processing has been performed at the cash register 120. The cashier system is a system for managing one or more cash registers. Although the refund information is transmitted from the cashier system to the server apparatus 100 in sequence SQ504, the refund information may be downloaded from the cashier system to the PC 110 and then transmitted from the PC 110 to the server apparatus 100. Further, acquisition of the refund information may be generated by analyzing the image taken by the imaging apparatus 130 at the server apparatus 100, or may be generated by analyzing the image taken by the imaging apparatus 130 at the imaging apparatus 130 and then transmitted to the server apparatus 100.

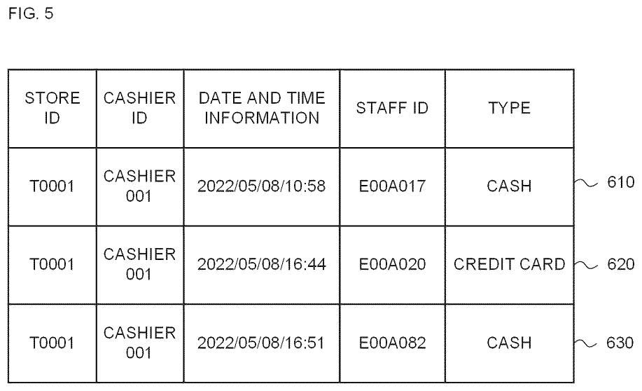

FIG. 5 shows an example of refund information. The refund information includes store ID, cashier ID, staff ID, date and time information, and type. The store ID includes identification information that identifies a store where the cash register 120 for which refund processing was performed is located. The cashier ID includes identification information that identifies the cash register 120 at which the refund processing was performed. The staff ID includes identification information that identifies a staff who performed refund processing. The date and time information includes date and time information when the refund processing was performed. The type includes type of payment regarding refund processing. More specifically, the type includes information such as whether the refund was performed in cash, by credit card, or by QR (Quick response) code in the refund processing.

For example, the controller 210 receives refund information from the cashier system at predetermined time, such as 12:00, 18:00, 21:00, etc. In an example in FIG. 5, refund information includes three records: record 610, record 620, and record 630. The reason for the three records is for simplicity of explanation, and actual refund information includes dozens to hundreds of records per refund information.

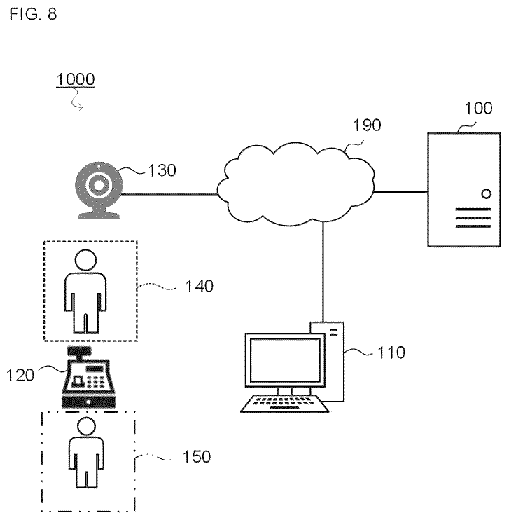

In sequence SQ505, the controller 210 performs determination processing to determine whether a situation has occurred that raises a predetermined flag shown in FIG. 8, which will be described later, based on the captured image, etc. regarding date and time the refund processing was performed.

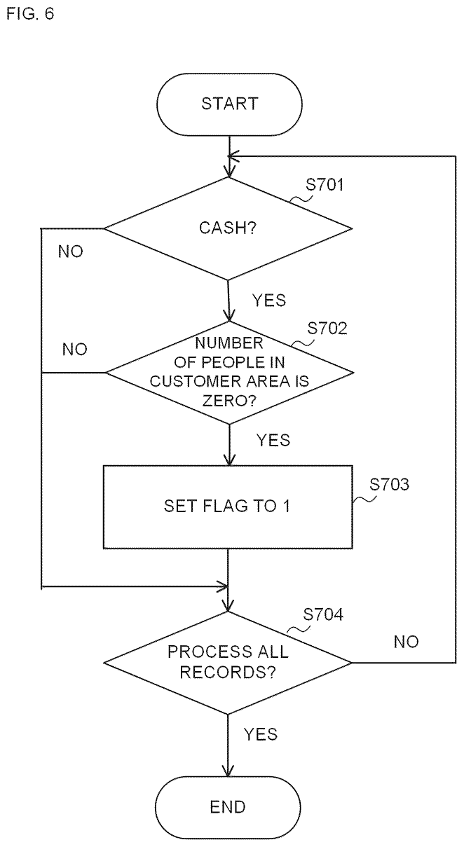

FIG. 6 is a flowchart showing an example of determination processing. The controller 210 performs the determination processing shown in FIG. 6 each time refund information is received.

In step S701, the controller 210 determines whether type of record to be processed, e.g., the record 610, is cash. If the type to be processed is cash, the controller 210 proceeds to step S702. If the type to be processed is not cash, the controller 210 proceeds to step S704.

In step S702, the controller 210 determines whether number of people included in the customer area 140 of the captured image corresponding to the date and time information included in the record to be processed is zero. The reason for determining whether the number of people included in the customer area 140 is zero is that absence of a customer in an area where the customer should be, even though refund processing is being performed with respect to the customer, suggests a possibility that fraud is being committed.

If number of people included in the customer area 140 of the captured image corresponding to the date and time information included in the record to be processed is zero, the controller 210 proceeds to step S703. If the number of people included in the customer area 140 of the captured image corresponding to the date and time information included in the record to be processed is not zero, the controller 210 proceeds to step S704.

In step S703, the controller 210 sets a flag (not shown) of the record to be processed to 1. Note that an initial value of the flag is zero.

In step S704, the controller 210 determines whether processing shown in FIG. 6 has been performed with respect to all records included in the refund information. When determining that the processing for all records included in the refund information has been performed, the controller 210 terminates the processing shown in FIG. 6. When determining that the processing with respect to all records included in the refund information has not been performed, the controller 210 returns processing to step S701.

In the sequence SQ506 shown in FIG. 5, the controller 210 transmits flag information to the client apparatus 110 in response to a request from the client apparatus 110, etc. The flag information includes, for example, date and time information of the record set to 1, cashier ID, etc.

As shown in FIG. 7, in sequence SQ507, the controller 310 of the client apparatus 110 controls to display a flag indicating a possibility of refund fraud that may occur, at timing when refund processing was performed at the cash register 120, on a timeline regarding the captured image based on the flag information.

FIG. 7 shows an example of a screen displayed on the output unit 340 of the client apparatus 110. As shown in FIG. 7, the screen includes a display area 910. The display area 910 displays a captured image (moving image) taken by the imaging apparatus 130. Further, the screen includes a timeline 920. The timeline 920 indicates time of the captured image displayed in the display area 910. A playback position display object 930 is an object that indicates imaging date and time of the captured image displayed in the display area 910. When the playback position display object 930 is at a leftmost position of the timeline 920, this position becomes a start position of playback of the captured image, and when the playback position display object 930 is at a rightmost position of the timeline 920, this position becomes an end position of playback of the captured image. Further, a user can operate the playback position display object 930 to specify the imaging date and time of the captured image to be displayed in the display area 910. A flag 940 is a flag indicating a possibility that refund fraud has occurred, which is displayed on the timeline 920. Date and time information 950 indicates imaging date and time of the captured image displayed in the display area 910.

As shown in FIG. 7, the flag 940 is displayed on the timeline in a manner that indicates timing when refund processing took place with possible refund fraud at the cash register 120. In other words, the flag 940 is displayed in a manner that indicates when refund fraud occurred in the cash register 120. As shown in FIG. 7, the display of flag 940 on the timeline is an example, and may be displayed in any manner as long as it is possible to understand the date and time when refund processing with a possibility of refund fraud at the cash register 120 was performed and to immediately confirm the captured image at that date and time.

In the example of FIG. 7, a user selects the flag 940 and performs a predetermined operation (e.g., double-clicking) or allows the playback position display object 930 to move to a position of the flag 940, in such a manner that the image taken at the time corresponding to the flag 940 is displayed in the display area 910. By visually confirming the captured image around the cash register 120 at the time corresponding to the flag 940 that is displayed in the display area 910, the user can confirm whether fraudulent refund processing is being performed with the image.

According to the present embodiment, if a predetermined condition is met, such as when the number of people in the customer area 140 included in the captured image is zero at the timing when the refund processing is performed at the cash register 120 where the refund processing is performed, a flag regarding refund fraud is displayed in association with the timeline. Therefore, the user does not need to confirm date and time for each refund processing and confirm the image at that date and time, but can immediately confirm whether fraudulent refund processing is being performed by operating a screen to confirm only the image taken at the date and time regarding the flag. In addition, by establishing a system such as the one shown in the present embodiment, it is possible to deter fraudulent refund processing.

(First Variation)

Hereinafter, a first variation of the first embodiment will be described.

FIG. 7 shows an example of system configuration of an information processing system 1000 according to the first variation.

An imaging apparatus 13 in the first variation image an area around a cash register 120 to include a customer area 140 and a work area 150 with respect to the cash register 120, and transmits an image to a server apparatus 100. Similar to the customer area 140, the work area 150 may be set via the client apparatus 110 or the like. The work area 150 is set to include a store staff who operates the cash register 120.

A controller 310 in the first variation displays a captured image regarding the cash register 120 on a screen. The screen includes a timeline regarding the captured image. If number of people in the customer area 140 regarding the cashier included in the captured image is zero at timing when refund processing is performed at the cashier, and number of people in the work area 150 regarding the cashier is one or less, a flag regarding refund fraud is displayed on the timeline. Here, the customer area 140 is an example of a first predetermined area. The work area 150 is an example of a second predetermined area. Further, number of people is zero is an example of a first predetermined condition. Number of people is one or less is an example of a second predetermined condition.

The information processing, etc. of the information processing system 1000 in the first variation will be described referring to FIG. 4. Main point that differs from the first embodiment will be described as follows.

In sequence SQ501, the imaging apparatus 130 images the area around the cash register 120 including a set area (e.g., the customer area 140 and the work area 150), and transmits the captured image to the server apparatus 100.

In sequence SQ503, the controller 210 in the first variation counts number of people in the customer area 140 and number of people in the work area 150 of the captured image. The controller 210 stores information on which area the number of people was counted or information on counted number of people in a predetermined storage area such as the storage unit 220 in association with the captured image.

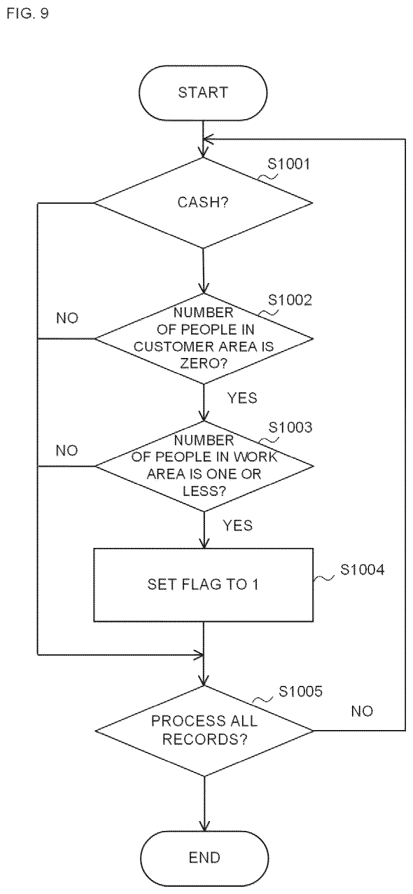

Determination processing in the first variation will be described referring to FIG. 9. FIG. 9 is a flowchart showing an example of determination processing in the first variation. The controller 210 performs the determination processing shown in FIG. 9 each time refund information is received.

In step S1001, the controller 210 determines whether type of record to be processed, e.g., record 610, is cash. If the type to be processed is cash, the controller 210 proceeds to step S1002. If the type to be processed is not cash, the controller 210 proceeds to step 1005.

In step S1002, the controller 210 determines whether the number of people included in the customer area 140 of the captured image corresponding to date and time information included in the record to be processed is zero. The reason for determining whether the number of people included in the customer area 140 is zero is that absence of a customer in an area where the customer should be, even though refund processing is being performed with respect to the customer, suggests a possibility that fraud is being committed.

If the number of people included in the customer area 140 of the captured image corresponding to the date and time information included in the record to be processed is zero, the controller 210 proceeds to step S1003. If the number of people included in the customer area 140 of the captured image corresponding to the date and time information included in the record to be processed is not zero, the controller 210 proceeds to step S1005.

In step S1003, the controller 210 determines whether the number of people included in the work area 150 of the captured image corresponding to date and time information included in the record to be processed is one or less. The reason for determining whether the number of people included in the work area 150 is one or less is because a possibility of refund fraud is higher when a single person is processing a refund than when two or more persons are processing a refund.

If the number of people included in the work area 150 of the captured image corresponding to the date and time information included in the record to be processed is one or less, the controller 210 proceeds to step S1004. If the number of people included in the work area 150 of the captured image corresponding to the date and time information included in the record to be processed is not one or less, the controller 210 proceeds to step S1005.

In step S1004, the controller 210 sets a flag (not shown) of the record to be processed to 1. Note that an initial value of the flag is zero.

In step S1005, the controller 210 determines whether the processing shown in FIG. 9 has been performed with respect to all the records included in refund information. When determining that the processing, as shown in FIG. 9, with respect to all records included in the refund information has been performed, the controller 210 terminates the processing shown in FIG. 9. When determining that the processing with respect to all records included in the refund information has not been performed, the controller 210 returns processing to step S1001.

According to the first variation, if the number of people in the customer area 140 included in the captured image is zero and the number of people in the work area 150 is one or less, a flag regarding refund fraud is displayed in association with the timeline.

(Other Variation)

In the above-described embodiments, etc., the controller 210 is described as receiving from the cashier system the refund information as shown in FIG. 5, which indicates that refund processing has been performed at the cash register 120. However, for example, the controller 210 may acquire refund information as shown in FIG. 5 by analyzing a captured image acquired from an imaging apparatus that takes an image of the cash register 120. With such a configuration, the processing shown in the above-described embodiment, etc. can be performed without acquiring information from a cashier system.

Further, the controller 210 may transmit refund information and flag information (0 or 1) corresponding to each record in the refund information to the client apparatus 110. Upon receiving such information, the controller 310 of the client apparatus 110 may, based on the flag information set to 0 as value, etc., set a flag indicating that refund processing has been performed on the timeline in a manner that indicates when the refund was processed (corresponding to a flag 960 and a flag 970 in FIG. 11, hereinafter referred to as “refund processing flag”). FIG. 11 is a diagram showing an example of a screen displayed on the output unit 340 of the client apparatus 110 (second case). Based on the flag information with 1 set as the value, etc., the controller 310 receiving such information displays a flag indicating a possibility of refund fraud on the timeline in a manner indicating the timing of processing regarding the refund fraud (corresponding to a flag 940 in FIG. 11, hereinafter referred to as the “refund fraud flag”). Further, the controller 310 can display a flag indicating that refund processing has been performed and a flag indicating a possibility that refund fraud has been committed in different manners on the timeline. The example shown in FIG. 11 shows flags in different colors, but is not limited thereto.

The controller 310 may display the flags in a different manner by changing shape of the flag. Further, the refund processing flag may be displayed so as to be identifiable according to the type of refund processing. Further, regarding the refund fraud flag, a desired combination of the conditions “number of people in the customer area is zero” and “number of people in the work area is one or less” (if both conditions are met, if either condition is met, if only former condition is met, if only latter condition is met), each may be displayed so as to be identifiable. To realize these, necessary flags shall be set in each case of YES in each of the steps from S1001 to S1003, respectively. When the refund processing flag and the refund fraud flag are attached with respect to the same timing, only one of them (the refund processing flag is desirable in most cases) may be displayed, or both may be displayed side by side (and even grouped together if necessary). The controller 310 may also switch between displaying a screen as shown in FIG. 11 or FIG. 7, depending on the setting or in response to an operation portion via the screen. In other words, the controller 310 may switch between displaying and non-displaying a flag indicating that refund processing has been performed, according to a setting or according to an operation portion via a screen.

In addition, the present invention may be provided in each of the following aspects.

(1) An information processing system, configured to: display a captured image regarding a cashier on a screen, wherein the screen includes a timeline regarding the captured image; and when the captured image meets a predetermined condition at timing when refund processing is performed at the cashier, displaying an object regarding refund fraud in association with the timeline.

(2) The information processing system according to (1), wherein the object is displayed in association with the timeline in a manner that indicates timing when refund processing is performed at the cashier.

(3) The information processing system according to (1) or (2), wherein when number of people in a predetermined area regarding the cashier included in the captured image meets a predetermined condition at timing when refund processing is performed at the cashier, the object is displayed on the timeline.

(4) The information processing system according to (3), wherein the predetermined area is a customer area regarding the cashier.

(5) The information processing system according to (3) or (4), wherein the predetermined condition is when number of people in the predetermined area is zero.

(6) The information processing system according to (1) or (2), wherein when number of people in a first predetermined area regarding the cashier included in the captured image meets a predetermined first condition at timing when refund processing is performed at the cashier, and number of people in a second predetermined area regarding the cashier meets a predetermined second condition, the object is displayed on the timeline.

(7) The information processing system according to (6), wherein the first predetermined area is a customer area regarding the cashier, and the second predetermined area is a work area regarding the cashier.

(8) The information processing system according to (6) or (7), wherein the first predetermined condition is that number of people in the first predetermined area is zero, and the second predetermined condition is that number of people in the second predetermined area is one or less.

(9) The information processing system according to any one of (1) to (8), wherein the refund processing is cash refund processing.

(10) An information processing method executed by an information processing system, comprising: displaying a captured image regarding a cashier on a screen, wherein the screen includes a timeline regarding the captured image; and when the captured image meets a predetermined condition at timing when refund processing is performed at the cashier, displaying an object regarding refund fraud in association with the timeline.

(11) A non-transitory computer readable storage medium storing a program that allows a computer to function as the information processing system according to any one of (1) to (9).

Of course, the present invention is not limited to the above aspects.

For example, part or all of the processing of the server apparatus 100 described above may be performed by the client apparatus 110.

Although various embodiments of the present invention have been described, these are presented as examples and are not intended to limit the scope of the invention. The novel embodiment can be implemented in various other forms, and various omissions, replacements, and changes can be made without departing from the abstract of the invention. The embodiment and its modifications are included in the scope and abstract of the invention and are included in the scope of the invention described in the claims and the equivalent scope thereof.

1. An information processing system, configured to:
display a captured image regarding a cashier on a screen, wherein
the screen includes a timeline regarding the captured image; and
when number of people in a customer area regarding the cashier included in the captured image is zero at timing when refund processing is performed at the cashier, display an object regarding refund fraud in association with the timeline.

2. An information processing system, configured to:
display a captured image regarding a cashier on a screen, wherein
the screen includes a timeline regarding the captured image; and
when number of people in a customer area regarding the cashier included in the captured image is zero at timing when refund processing is performed at the cashier, and number of people in a work area regarding the cashier is one or less, display an object regarding refund fraud in association with the timeline.

3. The information processing system according to claim 1, wherein:
the object is displayed in association with the timeline in a manner that indicates timing when refund processing is performed at the cashier.

4. The information processing system according to claim 1, wherein:
the refund processing is cash refund processing.

5. An information processing method executed by an information processing system, comprising:
displaying a captured image regarding a cashier on a screen, wherein
the screen includes a timeline regarding the captured image; and
when number of people in a customer area regarding the cashier included in the captured image is zero at timing when refund processing is performed at the cashier, displaying an object regarding refund fraud in association with the timeline.

6. An information processing method executed by an information processing system, comprising:
displaying a captured image regarding a cashier on a screen, wherein
the screen includes a timeline regarding the captured image; and
when number of people in a customer area regarding the cashier included in the captured image is zero at timing when refund processing is performed at the cashier, and number of people in a work area regarding the cashier is one or less, displaying an object regarding refund fraud in association with the timeline.

7. A non-transitory computer readable storage medium that stores a program which, when accessed and executed by a computer, causes the computer to function as the information processing system according to claim 1.
